(19) United States
(12) Patent Application Publication
(10) Pub. No.: US 2024/0099550 A1
(43) Pub. Date: Mar. 28, 2024

(54) CONVEYOR WAREWASHER AND METHOD FOR OPERATING A CONVEYOR WAREWASHER

(71) Applicant: ILLINOIS TOOL WORKS INC., Glenview, IL (US)

(72) Inventors: Harald DISCH, Elzach (DE); Martin SCHREMPP, Biberach (DE)

(21) Appl. No.: 18/475,360

(22) Filed: Sep. 27, 2023

(30) Foreign Application Priority Data
Sep. 28, 2022 (DE) 10 2022 125 035.0

(51) Int. Cl. A47L 15/42; A47L 15/00; A47L 15/24; G06V 20/50; G06V 20/60

(52) U.S. Cl. CPC A47L 15/4295; A47L 15/0026; A47L 15/0028; A47L 15/0034; A47L 15/241; G06V 20/50; G06V 20/60; A47L 2401/04; A47L 2501/01; A47L 2501/04; A47L 2501/06; A47L 2501/07; A47L 2501/10; A47L 2501/11; A47L 2501/12; A47L 2501/24; A47L 2501/26; A47L 2501/30

(57) ABSTRACT

A conveyor warewasher has at least one washing zone, at least one rinsing zone and a conveyor apparatus. A camera system is arranged above or below or to the side of the conveyor apparatus and is configured in order capture at least one image of a portion of the conveyor apparatus, preferably continuously or at predetermined or determinable times and/or events. An evaluation device is configured in order to evaluate and determine on the basis of the at least one image whether, at the time of the image capture, washware of the following washware category was present in the portion of the conveyor apparatus: reusable plasticware, in particular in the form of plastic trays, plastic mugs, plastic bowls, plastic covers for plastic bowls, and/or plastic plates.

### TECHNICAL FIELD

The present invention relates generally to the field of industrial rinsing, and in particular to a conveyor warewasher, such as a belt conveyor warewasher or a rack conveyor warewasher.

### BACKGROUND

Conveyor warewashers are used in the commercial sector. In contrast to domestic dishwashers, in which the washware to be cleaned remains stationary in the machine during cleaning, in conveyor warewashers the washware is conveyed through different treatment zones of the conveyor warewasher.

In the case of conveyor warewashers, the washware, for example dishes, pots, glasses, cutlery, and other utensils to be cleaned, are conveyed through a plurality of treatment zones, for example through at least one pre-washing zone, at least one main washing zone, at least one post-washing zone or pre-rinsing zone, at least one fresh water rinsing zone, and at least one drying zone. However, different types of washware require different treatment parameters for the individual process steps due to their application, their degree of soiling, their shape, and the material used. However, in today's conveyor warewashers, there is usually no automatic differentiation of the types of washware, so that the conventional systems are often designed as a compromise in order to be usable for several different types of washware.

Increasingly, more and more gastronomic companies are switching to reusable tablewares, as required by law. However, washing cups, dishes, and refillable plastic bottles requires a special technique.

In order to achieve an optimum rinsing and drying result, the machine, the basket system, and the chemistry must be coordinated with each other.

Accordingly, there is a need for appropriate plastic rinsing solutions for a wide variety of reusable containers.

Another problem with industrial rinsing can be seen in the fact that conveyor warewashers are mostly operated continuously during a rinsing shift or during rinsing days. The cleaning staff loads the available washware onto the conveyor apparatus on the dirty side of the conveyor warewasher, so that the washware is then transported through the respective treatment zones of the conveyor warewasher with the aid of the conveyor apparatus and dispensed on the clean side after being washed, rinsed, and dried. With such a procedure—at least for certain periods of the washing shift or washing day—mixed loading of the conveyor warewasher is unavoidable.

The problem with the conveyor warewashers known from the state of the art can be seen in particular in the fact that reusable plasticware is not optimally cleaned or dried with standard programs. On the other hand, in practice, it is not reasonable for the cleaning staff to change or fit the conveyor warewasher's treatment program accordingly whenever reusable plasticware is placed on the conveyor apparatus.

### SUMMARY

According to the present invention, the object is to specify a conveyor warewasher which is, in particular, optimized for reusable plasticware, such as plastic trays, plastic tumblers, plastic bowls, plastic covers for plastic bowls, and/or plastic plates, wherein the conveyor warewasher comprises intelligent cleaning technology to adjust the treatment parameters to the “reusable plasticware” washware category as needed.

Accordingly, the invention relates in particular to a conveyor warewasher for cleaning washware, wherein the conveyor warewasher comprises at least one washing zone and at least one rinsing zone, as well as a conveyor apparatus for conveying the washware through the at least one washing zone and the at least one rinsing zone.

The conveyor warewasher according to the invention is characterized in particular by the fact that it comprises a camera system which is arranged above or below the conveyor apparatus or laterally to the conveyor apparatus, and is designed to record at least one image of an area of the conveyor apparatus, preferably continuously or at predetermined or determinable times and/or events. Furthermore, an evaluation device is used which is designed, based on the at least one image, to evaluate and to determine whether washware of the following washware category was present in the area of the conveyor apparatus at the time at which the image was recorded:
Reusable plasticware, in particular in the form of plastic trays, plastic tumblers, plastic cups, plastic bowls, plastic covers for plastic bowls, plastic plates, plastic covers for plastic plates, plastic heat-retaining cloches, plastic cutlery, plastic containers for pre-portioning foods, and/or plastic lids for plastic containers for pre-portioning foods.

The advantages achievable with the solution according to the invention are obvious: the camera system as a washware detector device enables an automatic detection of washware by means of camera-based image processing. In particular, all relevant categories of washware can be detected using the same detector system, without having to use different sensors or coded washware racks. The washware categories that can be detected with the detector system relate to reusable plasticware in particular, but also to other washware categories, such as cutlery or cutlery parts, pots, pans or GN containers, glasses, plates, cups, or bowls made of porcelain.

In order to implement the detector system, it is provided in particular that the camera system has an image processing device assigned to it which is designed for the in particular optional preprocessing of the at least one image recorded by the camera system, for the segmentation of the in particular optionally preprocessed image, and for the feature extraction and classification of objects contained in the image, wherein the evaluation device is designed, based on the classification that is performed, to evaluate and to determine whether washware of the washware category “reusable plasticware” was present in the area of the conveyor apparatus at the time at which the image was recorded.

The conveyor warewasher according to the invention comprises in particular a control device which is designed to automatically select a previously defined or definable treatment program according to which the washware is to be treated in the at least one washing zone and/or in the at least one rinsing zone and/or in at least one drying zone of the conveyor warewasher for the determined washware category “reusable plasticware,” and set the process parameters associated with the selected treatment program, preferably with a time delay and, in particular, preferably as a function of a transport speed of the conveyor apparatus, and/or to set a transport speed of the conveyor apparatus which is predetermined or determinable, preferably with a time delay.

In other words, the conveyor warewasher according to the invention has a certain degree of intelligence, so that when washware of the washware category “reusable plasticware” is detected, the optimum treatment parameters are preferably set automatically, so that optimum cleaning and drying results are achieved.

No, or at least significantly reduced, training of cleaning staff is necessary for the appropriate selection of a program cycle. In addition, fewer returns occur due to the automatically selected program cycle, and the effort required for pre- and post-treatment of washware of the washware category “reusable plasticware” is significantly reduced.

In particular, it is provided in this context that the control device is designed to select a predetermined or determinable value of a volumetric flow rate of washing liquid to be sprayed per unit of time in the at least one washing zone automatically and when determining the washware category “reusable plasticware,” and to set the volumetric flow rate of washing liquid sprayed per unit of time to the selected value.

Alternatively or in addition thereto, the control device is designed to select a predetermined or determinable value of a nozzle pressure with which the washing liquid is sprayed in the at least one washing zone automatically and when determining the washware category “reusable plasticware,” and to set the nozzle pressure to the selected value.

Here, the invention is based on the knowledge that washware in the washware category “reusable plasticware,” in particular plastic tumblers and associated lids, are relatively light, so that they must either be fixed in place, which requires special basket systems, or the mechanics, i.e., the nozzle pressure, must be reduced when these items are washed in the conveyor warewasher.

The reduction in the volumetric flow rate of washing liquid to be sprayed per unit of time in the at least one washing zone when detecting washware of the washware category “reusable plasticware” takes into account that reusable tableware is generally only lightly soiled compared to, for example, GN containers, pans, pots, or cutlery items. Therefore, it is possible to spray a reduced amount of washing liquid per unit of time in the at least one washing zone without negatively affecting the washing result.

Alternatively or in addition to the aspects mentioned above, in embodiments of the warewasher according to the invention, it is provided that the control device is designed to select a predetermined or determinable value of a volumetric flow rate of rinsing liquid to be sprayed per unit of time in the at least one rinsing zone automatically and when determining the washware category “reusable plasticware,” and to set the volumetric flow rate of rinsing liquid sprayed per unit of time to the selected value.

It also makes sense here to reduce the amount of rinsing liquid sprayed per unit of time when detecting washware in the washware category “reusable plasticware” in order to save resources (water, energy, and chemicals).

Similarly, the control device should be designed to select a predetermined or determinable value of a nozzle pressure with which the rinsing liquid is sprayed in the at least one rinsing zone automatically and when determining the washware category “reusable plasticware,” and set the nozzle pressure to the selected value. As with the nozzle pressure with which the washing liquid is sprayed in the at least one washing zone, it is advisable here to reduce the nozzle pressure with which the rinsing liquid is sprayed in the at least one rinsing zone, since plastic washware must retain their position on the conveyor apparatus during rinsing without requiring the use of special basket systems for this purpose.

In particular, the control device should be designed to select a predetermined or determinable value of a temperature of the rinsing liquid to be sprayed in the at least one rinsing zone automatically and when determining the washware category “reusable plasticware,” and to adjust the temperature of the rinsing liquid sprayed in the at least one rinsing zone to the selected value. In particular, it is herein intended that the temperature of the rinsing liquid to be sprayed in the at least one rinsing zone is increased when the “reusable plasticware” washware category is detected, since reusable plasticware has only a low specific heat capacity.

In order to achieve optimum cleaning and drying results, it is preferably furthermore provided that the control device is designed to set a predetermined or determinable value of a quantity of clear-rinsing agent sprayed per unit of time in the at least one rinsing zone to a selected value, automatically and when determining the washware category “reusable plasticware.” Alternatively or additionally, it is provided that the cleaning chemicals used in the washing zone are adapted accordingly. In this context, it is particularly intended that when the “reusable plasticware” washware category is detected, a switch is made to a special rinsing agent for plastic washware.

Since reusable plasticware requires high-performance drying, it is provided in accordance with further embodiments of the invention that the control device is designed to select a predetermined or determinable value of a volumetric flow rate/nozzle pressure of drying air to be sprayed per unit of time in the at least one drying zone automatically and when determining the washware category “reusable plasticware,” and/or to select the temperature of the drying air, and accordingly set the volumetric flow rate/nozzle pressure/temperature of the drying air to the selected value.

In particular, the control device is designed to select a predetermined or determinable value of a volumetric flow rate of washing liquid to be sprayed per unit of time in the at least one washing zone automatically and when determining the washware category “reusable plasticware,” and to adjust the volumetric flow rate of washing liquid sprayed per unit of time to the selected value; and/or

wherein the control device is designed to select a predetermined or determinable value of a nozzle pressure at which the washing liquid is sprayed in the at least one washing zone automatically and when determining the washware category “reusable plasticware,” and to adjust the nozzle pressure to the selected value; and/or
wherein the control device is designed to select a predetermined or determinable value of a temperature of the washing liquid to be sprayed in the at least one washing zone automatically and when determining the washware category “reusable plasticware,” and to adjust the temperature of the washing liquid sprayed in the at least one washing zone to the selected value; and/or
wherein the control device is designed to select a predetermined or determinable value of a volumetric flow rate of rinsing liquid to be sprayed per unit of time in the at least one rinsing zone automatically and when determining the washware category “reusable plasticware,” and to set the volumetric flow rate of rinsing liquid sprayed per unit of time to the selected value; and/or
wherein the control device is designed to select a predetermined or determinable value of a nozzle pressure with which the rinsing liquid is sprayed in the at least one rinsing zone automatically and when determining the washware category “reusable plasticware,” and to adjust the nozzle pressure to the selected value; and/or
wherein the control device is designed to select a predetermined or determinable value of a temperature of the rinsing liquid to be sprayed in the at least one rinsing zone automatically and when determining the washware category “reusable plasticware,” and to set the temperature of the rinsing liquid sprayed in the at least one rinsing zone to the selected value; and/or
wherein the control device is designed to set a predetermined or determinable value of a quantity of clear-rinsing agent sprayed per unit of time in the at least one rinsing zone to a selected value automatically and when determining the washware category “reusable plasticware”; and/or
wherein the control device is designed to set a predetermined or determinable value of an amount of cleaning chemical sprayed per unit of time in the at least one washing zone or in an additional intermediate zone to a selected value automatically and when determining the washware category “reusable plasticware”; and/or
wherein the control device is designed to select a predetermined or determinable value of a volumetric flow rate/nozzle pressure of drying air to be sprayed per unit of time in the at least one drying zone automatically and when determining the washware category “reusable plasticware,” and adjust the volumetric flow rate/nozzle pressure of drying air sprayed per unit of time to the selected value; and/or
wherein the control device is designed to switch between different chemical products, in particular between a universal rinsing agent for washware made of porcelain, glass, or metal, and a special rinse aid for washware made of plastic, automatically and when determining the washware category “reusable plasticware.”

According to an aspect of the present invention, the conveyor warewasher according to the invention is capable of “artificially” generating knowledge from experience, that is, via machine learning. The control device of the conveyor warewasher learns from examples and can generalize on this basis after the learning phase has been completed. To this end, algorithms of the control device use machine learning to build a statistical model based on training data which is tested against the test data.

Specifically, according to exemplary embodiments of this aspect, it is intended that the control device of the conveyor warewasher is designed, in particular during a learning or observation phase, over at least one observation period and preferably over a plurality of observation periods, each of which preferably relates to a rinse shift or rinsing day of the conveyor warewasher or a time period thereof, to determine the temporal development of the load level of the conveyor apparatus with washware of the washware category “reusable plasticware” to be transported through the treatment zone of the conveyor warewasher.

The control device is preferably furthermore designed to detect a pattern or regularity based on the determined temporal development of the load level of the conveyor apparatus with washware of the washware category “reusable plasticware.”

According to further embodiments of this aspect, it is provided that the control device is furthermore designed to divide the observation period, which preferably relates to a washing shift or a washing day of the conveyor warewasher or a time segment thereof, into a first subperiod and into at least one further, second subperiod, wherein, in the first subperiod of the observation period, the determined load level, in particular the average load level, of the conveyor apparatus with washware of the washware category “reusable plasticware” corresponds to a first relative value or falls within a first relative value range, and wherein, in the at least one second subperiod of the observation period, the determined load level, in particular the average load level, of the conveyor apparatus with washware of the washware category “reusable plasticware,” corresponds to a second relative value or falls within a second relative value range.

In particular, it is provided that the first relative value of the in particular average load level of the conveyor apparatus with washware of the washware category “reusable plasticware” corresponds to an average load level of the conveyor apparatus with the washware of the washware category “reusable plasticware” which is higher than the average load level of the conveyor apparatus with the washware of the washware category “reusable plasticware,” which relates to the second relative value of the in particular average load level of the conveyor apparatus with the washware of the washware category “reusable plasticware.”

According to implementations of the control device, which is designed to artificially generate knowledge from experience, it is provided that the control device is designed, in particular upon completing the learning or observation phase, preferably automatically and even more preferably optionally automatically, during operation of the conveyor warewasher during a washing shift or during a washing day, to initiate at least one first measure influencing the treatment of the washware of the washware category “reusable plasticware” in the treatment zones of the conveyor warewasher for the first subperiod; and, for the at least one second subperiod, to initiate at least one second measure influencing the treatment of the washware of the washware category “reusable plasticware” in the treatment zones of the conveyor warewasher.

These measures affecting the treatment of the washware of the washware category “reusable plasticware” in the treatment zones of the conveyor warewasher consist, in particular, of one of the measures listed below:
Changing, in particular reducing, the temperature of the rinsing liquid to be sprayed in the at least one rinsing zone; and/or
Changing, in particular reducing, the pressure of the rinsing liquid to be sprayed in the at least one rinsing zone; and/or
Changing, in particular increasing, the amount of rinsing liquid sprayed per unit of time in the at least one rinsing zone; and/or
Changing, in particular increasing, the temperature of washing liquid to be sprayed in the at least one washing zone; and/or
Changing, in particular reducing, the pressure of washing liquid to be sprayed in the at least one washing zone; and/or
Changing, in particular reducing, the amount of washing liquid to be sprayed per unit of time in the at least one washing zone; and/or
Changing, in particular increasing, the temperature of drying air to be sprayed in a drying zone of the conveyor warewasher; and/or
Changing, in particular increasing, the pressure of drying air to be sprayed in a drying zone of the conveyor warewasher; and/or
Changing, in particular increasing, the amount of drying air to be sprayed per unit of time in a drying zone of the conveyor warewasher; and/or
Changing, in particular increasing, the amount of clear-rinsing agent to be metered into the rinsing liquid per unit of time; and/or;
Changing, in particular reducing, the transport speed of the conveyor apparatus.

In accordance with implementations of the conveyor warewasher according to the invention, it is provided that the control device is designed to output a message, in particular an error or warning message, in particular to the cleaning staff assigned to the conveyor warewasher and/or the operator of the conveyor warewasher, if it is determined that a current value or a value of the degree of conveyor apparatus loading with washware of the washware category “reusable plasticware” as averaged over a predetermined or determinable time period lies below or above a predetermined or determinable value of the conveyor apparatus loading with this washware category.

Alternatively or additionally, it is conceivable that the control device of the conveyor warewasher is designed to determine a temporal development of the conveyor apparatus loading with washware of the washware category “reusable plasticware” to be transported through the treatment zones of the conveyor warewasher and/or to generate statistics on the degree of conveyor apparatus loading with washware of the washware category “reusable plasticware.”

In this context, it is particularly useful that the control device is also designed to generate a corresponding message as a function of the determined temporal development and/or as a function of the generated statistics and/or to output a corresponding message to, in particular, the operator of the conveyor warewasher, wherein the message preferably contains a recommendation for optimized operation of the conveyor warewasher, in particular with regard to cleaning efficiency.

The invention further relates to a method for operating a conveyor warewasher, in particular a conveyor warewasher of the aforementioned type according to the invention, or a conveyor warewasher according to the generic term of claim 1.

In the method according to the invention, it is provided that, in particular during an observation phase over an observation period which preferably relates to a washing shift or washing day of the conveyor warewasher, [a temporal development of a load level of the conveyor apparatus with washware of the washware category “reusable plasticware” is determined by the detection device] and a pattern or regularity is preferably derived on the basis of the determined temporal development.

Alternatively or additionally, it is provided that, in particular during an observation phase over an observation period which preferably relates to a washing shift or washing day of the conveyor warewasher, statistics are generated regarding the time of the degree of conveyor apparatus loading with washware of the washware category “reusable plasticware.”

In this context, it is advisable for an error or warning message to be issued in particular to the cleaning staff assigned to the conveyor warewasher and/or to the operator of the conveyor warewasher if it is determined that the determined, in particular average, degree of conveyor apparatus loading with washware of the washware category “reusable plasticware” falls below or exceeds a predetermined or determinable load level.

Alternatively or additionally, in the further embodiment of the method according to the invention, it is provided that, as a function of the determined temporal development and/or as a function of the compiled statistics, a corresponding message is generated and/or output to, in particular, the operator of the conveyor warewasher; wherein the message preferably contains a recommendation for optimized operation of the conveyor warewasher, in particular with regard to cleaning efficiency.

### BRIEF DESCRIPTION OF THE DRAWING

In the following, the invention is described in further detail with reference to the enclosed drawing on the basis of an exemplary embodiment.

The following are shown:
FIG. 1 a schematic longitudinal sectional view of a conveyor warewasher according to an exemplary embodiment of the invention.

### DETAILED DESCRIPTION

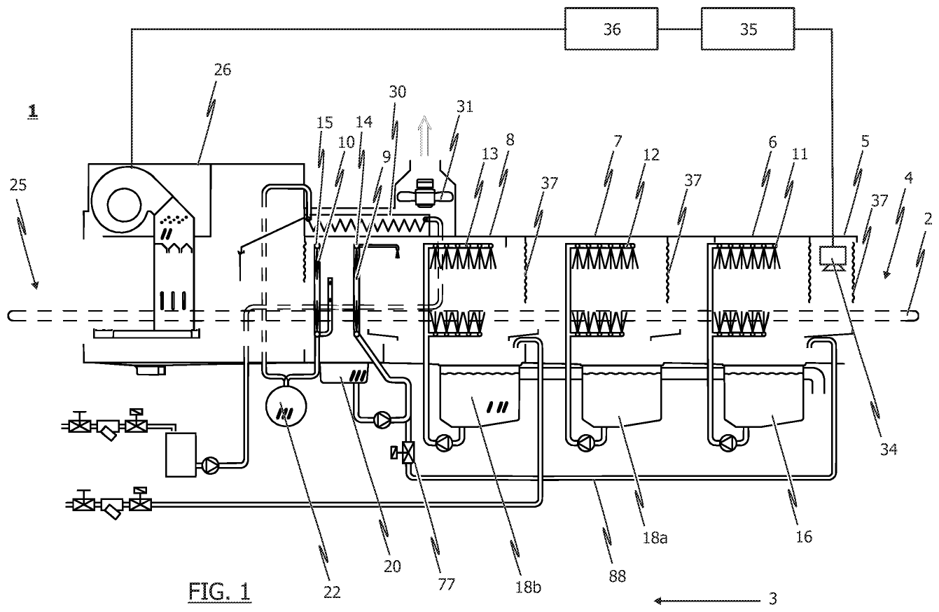

FIG. 1 shows a conveyor warewasher 1 with a conveyor apparatus 2 for conveying washware not shown in the drawings through the conveyor warewasher 1 in a direction of conveyance 3.

The conveyor apparatus 2 can be, for example, a conveyor belt, which is preferably configured as a multi-member plastic conveyor belt and is continuously driven by an electric drive not shown in FIG. 1, so that the washware placed upon the conveyor belt 2 is conveyed through the various treatment zones 6, 7, 8, 9, 10, and 26 of the conveyor warewasher 1 according to the illustration in FIG. 1.

Typically, the washware conveyed in the direction of conveyance 3 is placed upon the conveyor apparatus or conveyor belt 2 in the area of the inlet 4. According to the direction of conveyance 3 indicated by the arrow, the washware is then conveyed from the inlet 4 into an inlet tunnel 5.

The conveyor warewasher 1 according to the first embodiment of the present invention has at least one washing zone, for example as shown in FIG. 1, a pre-washing zone 6, as well as a first main washing zone 7 and a second main washing zone 8, which are arranged downstream of the pre-washing zone 6 when viewed in the direction of conveyance 3.

In the conveyor warewasher 1 shown in FIG. 1, a post-washing zone 9 and a rinsing zone 10 downstream of the post-washing zone 9 are arranged downstream of the at least one washing zone 6, 7, 8 when viewed in the direction of conveyance 3.

In the illustration according to FIG. 1, the conveyor apparatus 2 is shown as a circumferential conveyor belt. However, conveyor racks in which the not explicitly shown washware is inserted and which are placed on the top of the conveyor belt are also conceivable as the conveyor apparatus 2.

When viewed in the direction of conveyance 3, the washware received either directly on the conveyor belt 2 or held by racks runs in the direction of conveyance 3 through the inlet tunnel 5, the subsequent pre-washing zone 6, the first main washing zone 7, the second main washing zone 8, the post-washing zone 9, the rinsing zone 10, a drying zone 26, and into an outlet path 25.

Spray nozzles 11, 12, 13, 14, and 15 are respectively associated with the aforementioned treatment zones 6, 7, 8, 9, and 10 of the conveyor warewasher 1, via which nozzles liquid is sprayed onto the washware conveyed by the conveyor apparatus 2 through the respective treatment zones 6, 7, 8, 9, and 10. Each treatment zone 6, 7, 8, 9, and 10 is associated with a tank 16, 18, 20, and 22 in which sprayed liquid is received and/or in which liquid is provided for the spray nozzles of the respective zones. In the conveyor warewasher 1 shown in FIG. 1, rinsing liquid is sprayed onto the washware, not shown in the illustrations, in the form of fresh water, which may be pure or mixed with further additives such as rinsing agents, via the spray nozzles 15 of the rinsing zone 10 arranged above and below or to the side of the conveyor belt.

A portion of the sprayed rinsing liquid is conveyed from zone to zone in a cascading system counter to the direction of conveyance 3 of the washware. The remaining portion is guided directly into the pre-wash tank 16 via a valve 77 and a bypass line 88.

The sprayed rinsing liquid is collected in the tank 20 (post-wash tank 20) of the post-washing zone 9, from which it is conveyed via a pump system to the spray nozzles 14 (post-wash nozzles 14) of the post-washing zone 9. In the post-washing zone 9, washing liquid is rinsed from the washware. The liquid resulting from this flows into the wash tank 18b of the second main washing zone 8, is usually provided with a cleaning agent and then sprayed onto the washware by a pumping system via the nozzles 13 (wash nozzles 13) of the second main washing zone 8.

Liquid flows from the wash tank 18b of the second main washing zone 8 into the wash tank 18a of the first main washing zone 7. From there, the liquid is again sprayed onto the washware by a further pump system via the wash nozzles 12 of the first main washing zone 7. From the wash tank 18a of the first main washing zone 7, the liquid then flows into the pre-wash tank 16 of the pre-washing zone 6. Liquid in the pre-wash tank 16 is sprayed onto the washware by a pumping system via the pre-wash nozzles 11 of the pre-washing zone 6 in order to remove coarse impurities from the washware.

The individual rinsing systems of the treatment zones 6, 7, 8, 9, and 10 ensure that the washware is sprayed from both the top and the bottom.

The respective zones 6, 7, 8, 9, and 10 of the conveyor warewasher 1 can be separated from one another via separating curtains 37. In the embodiment shown in FIG. 1, the inlet tunnel 5 itself is also separated from the inlet 4 via a separating curtain 37. The provision of separating curtains 37 can prevent washing liquid and rinsing liquid from splashing out and steam from escaping from the conveyor warewasher.

The aforementioned drying zone 26 follows the rinsing zone 10 in the direction of conveyance 3 of the washware. In the drying zone 26, the washware is dried with dry and heated air in order to blow off or dry the moisture that is present on the washware. In order to maintain the moisture content of the air within a range that is favorable for drying, it is conceivable, for example, to supply room air via an opening, for example through the exit opening for the washware. The warm and moistened air is extracted from the drying zone 26, for example, by means of a fan 31 via a further opening.

It is advantageous for the exhaust air from the drying zone 26 to pass through a device for heat recovery 30, in which a condenser can be provided. The heat recovery device 30 serves to recover at least a portion of the heat energy contained in the exhaust air. In today's belt/rack conveyor warewashers, the washware is conveyed through a plurality of treatment zones, such as pre-washing zones, main washing zones, post-washing zones, rinsing zones, and drying zones.

As already indicated, different types of washware in the treatment zones of the conveyor warewasher require different treatment parameters. However, with the currently known conveyor warewashers, there is no automatic differentiation of the types of washware to be treated, so that conventional systems are typically designed as a compromise, such that they are more or less efficient for multiple types of washware. This approach leads to the fact that significantly more resources (energy, water, chemicals, etc.) are generally used in order to treat the washware than would actually be necessary.

The conveyor warewasher 1 according to the invention, as shown for example in FIG. 1, is characterized in that the conveyor warewasher 1 has a camera system 34, which is disposed above the conveyor apparatus 2 and is configured in order to take at least one image of an area of the conveyor apparatus 2, preferably continuously or at predetermined or determinable times and/or events.

The camera system 34 is associated with an image processing device 35, which is configured in order to, in particular, optionally pre-process the at least one image captured by the camera system 34, to segment the particularly optionally pre-processed image, to extract features, and to classify objects contained in the image (washware).

Furthermore, an evaluation device is provided which is designed, based on the classification that is performed, to evaluate and to determine whether washware of the washware category “reusable plasticware” was present in the area of the conveyor warewasher at the time that the image was recorded. This washware category is to be understood in particular as plasticware in the form of plastic trays, plastic tumblers, plastic bowls, plastic covers for plastic bowls, and/or plastic plates.

The term “category” as used herein means, in particular, a grouping of washware of different washware types into categories which together form a classification or washware category. The types of a category of washware have in common that they are optimally treatable according to the same or similar treatment parameters.

With regard to the “reusable plasticware” category of washware that is specifically considered in the present invention, it should be noted that washware in this category of washware are, in particular, relatively lightweight washware.

Accordingly, when treating such washware in the treatment zones of the conveyor warewasher 1, the mechanism must be adjusted accordingly to prevent the washware that are picked up by the conveyor apparatus 2 of the conveyor warewasher 1 from losing their orientation, position, location, and/or orientation on the conveyor apparatus 2 due to increased nozzle pressure.

On the other hand, the “reusable plasticware” washware category considered herein is characterized by plasticware becoming damaged when treated with cleaning liquid that is too hot. Furthermore, the greatest challenge in the cleaning of reusable plasticware is the drying process, since plastic does not store heat nearly as well as, for example, ceramic or glass, and only dries very slowly. Therefore, when the washware category “reusable plasticware” is detected, the aim is to adapt the washing and drying process of the conveyor warewasher 1 such that, after treatment of the washware in the conveyor warewasher 1, they can be stacked one inside the other and put away without residual moisture. It is also conceivable to provide the at least one drying zone of the conveyor warewasher 1 with a cooling unit at the end of the conveyor apparatus 2 for cooling the reusable plasticware in order to avoid condensation at the machine outlet, which may cause mold.

For this purpose, in the conveyor warewasher 1 schematically shown in FIG. 1, the control device 36 is designed to automatically select a predetermined or determinable treatment program according to which the washware is to be treated in the at least one washing zone 6, 7, 8, 9, and/or in the at least one rinsing zone 10 and/or in at least one drying zone for the determined washware category “reusable plasticware,” and set the process parameters associated with the selected treatment program, preferably with a time delay, and, in particular, preferably as a function of the transport speed of the conveyor apparatus 2. Alternatively or additionally, a predetermined or determinable transport speed of the conveyor apparatus 2 is preferably set with a time delay. Thereby, the contact time of the washware in the individual treatment zones of the conveyor warewasher 1 can be extended.

In particular, the control device 36 is designed to do the following, automatically and upon detecting the washware category “reusable plasticware”:
select a predetermined or determinable value of a volumetric flow rate of washing liquid to be sprayed per unit of time in the at least one washing zone 6, 7, 8, 9 and to adjust the volumetric flow rate of washing liquid sprayed per unit of time to the selected value; and/or
select a predetermined or determinable value of a nozzle pressure with which the washing liquid is sprayed in the at least one washing zone 6, 7, 8, 9 and set the nozzle pressure to the selected value; and/or
select a predetermined or determinable value of a temperature of the washing liquid to be sprayed in the at least one washing zone 6, 7, 8, 9 and adjust the temperature of the washing liquid sprayed in the at least one washing zone 6, 7, 8, 9 to the selected value; and/or
select a predetermined or determinable value of a volumetric flow rate of rinsing liquid to be sprayed per unit of time in the at least one rinsing zone 10, and adjust the volumetric flow rate of rinsing liquid sprayed per unit of time to the selected value; and/or
select a predetermined or determinable value of a nozzle pressure at which the rinsing liquid is sprayed in the at least one rinsing zone 10, and set the nozzle pressure to the selected value; and/or
select a predetermined or determinable value of a temperature of the rinsing liquid to be sprayed in the at least one rinsing zone 10, and adjust the temperature of the rinsing liquid sprayed in the at least one rinsing zone 10 to the selected value; and/or
set a predetermined or determinable value of a quantity of clear-rinsing agent sprayed per unit of time in the at least one rinsing zone 10 to a selected value; and/or
set a predetermined or determinable value of a quantity of cleaning chemical sprayed per unit of time in the at least one washing zone 6, 7, 8, 9 or in an additional intermediate zone to a selected value; and/or
select a predetermined or determinable value of a volumetric flow rate/nozzle pressure of drying air to be sprayed per unit of time in the at least one drying zone, and adjust the volumetric flow rate/nozzle pressure of drying air sprayed per unit of time to the selected value; and/or
switch between different chemical products, in particular between a universal rinsing agent for washware made of porcelain, glass, or metal and a special rinsing liquid for plastic washware.

According to a further aspect of the present invention, the control device 36 of the conveyor warewasher 1 is designed, in particular during a learning or observation phase, over at least one observation period and preferably over a plurality of observation periods, each of which preferably relates to a rinse shift or rinsing day of the conveyor warewasher 1 or a time period thereof, to determine a temporal development of the load level of the conveyor apparatus 2 with the washware of the washware category “reusable plasticware” to be transported through the treatment zone of the conveyor warewasher 1. In this context, the control device 36 is preferably furthermore designed to derive a pattern or regularity based on the determined temporal development of the load level of the conveyor apparatus 2 with washware of the washware category “reusable plasticware.”

In this context, it is suitable, for example, for the control device 36 to be designed to divide the observation period, which preferably relates to a washing shift or washing day of the conveyor warewasher 1 or time segment thereof, into a first subperiod and at least one further, second subperiod, wherein, in the first subperiod of the observation period, the determined, in particular average, load level of the conveyor apparatus 2 with washware of the washware category “reusable plasticware” corresponds to a first relative value or falls within a first relative value range. On the other hand, in the at least one second subperiod of the observation period, the determined, in particular average load level of the conveyor apparatus 2 with the washware of the washware category “reusable plasticware” corresponds to a second relative value and falls within a second relative value range.

In this context, it is conceivable that the first relative value of the in particular average load level of the conveyor apparatus 2 with washware of the washware category “reusable plasticware” corresponds to a load level of the conveyor apparatus 2 with washware of the washware category “reusable plasticware” which is higher than the load level of the conveyor apparatus 2 with washware of the washware category “reusable plasticware” that relates to the second relative value of the in particular average load level of the conveyor apparatus 2 with washware of this washware category.

In a further development of this aspect relating to machine learning, the control device 36 is designed, in particular after the end of the learning or observation phase, preferably automatically and even more preferably optionally automatically, during the operation of the conveyor warewasher 1 during a washing shift or washing day for the first subperiod, to initiate at least one first measure influencing the treatment of the washware of the washware category “reusable plasticware” in the treatment zones of the conveyor warewasher 1; and, for the at least one second subperiod, to initiate at least one second measure influencing the treatment of the washware of the washware category “reusable plasticware” in the treatment zones of the conveyor warewasher 1.

Alternatively or in addition to the aspects mentioned above, the control device 36 of the conveyor warewasher 1 according to the invention is, in particular, designed to output a message, in particular an error or warning message, in particular to the cleaning staff assigned to the conveyor warewasher 1 and/or to the operator of the conveyor warewasher 1 if it is determined that a current value or a value—as averaged over a time period that is, in particular, predetermined or determinable—of the load level of the conveyor apparatus 2 with washware of the washware category “reusable plasticware” is below or above a predetermined or determinable value of a load level of the conveyor apparatus 2 with washware of this washware category.

In principle, it is also conceivable that the control device 36 is designed to determine a temporal development of the load level of the conveyor apparatus 2 with washware of the washware category “reusable plasticware” to be transported through the treatment zones of the conveyor warewasher 1 and/or to generate statistics on the load level of the conveyor apparatus 2 with washware of the washware category “reusable plasticware.”

In this context, it is advisable that the control device 36 is designed to generate a corresponding message as a function of the determined temporal development and/or as a function of the generated statistics and/or to output a corresponding message to, in particular, the operator of the conveyor warewasher 1. The notification may comprise, for example, a recommendation for an operation of the conveyor warewasher 1 that is optimized with regard to cleaning efficiency in particular.

Alternatively or additionally, the message can also be used for status-based monitoring of the conveyor warewasher 1 or for the purpose of “predictive maintenance,” for example to indicate a time to refill special cleaning chemistry for the treatment of reusable plasticware to the operator of the conveyor warewasher 1.

The invention is not limited to the embodiment of the conveyor warewasher according to the invention shown in FIG. 1, but results from a summary of all features disclosed herein.

1. A conveyor warewasher for cleaning washware, wherein the conveyor warewasher comprises at least one washing zone and at least one rinsing zone as well as a conveyor apparatus for conveying the washware through the at least one washing zone and the at least one rinsing zone,
characterized in that
the conveyor warewasher has a camera system, which is arranged above or below or to the side of the conveyor apparatus and is configured in order capture at least one image of a portion of the conveyor apparatus, wherein an evaluation device is further provided, which is configured in order to evaluate and determine on the basis of the at least one image whether, at the time of the image capture, washware of the following washware category was present in the portion of the conveyor apparatus:
reusable plasticware, in the form of plastic trays, plastic mugs, plastic cups, plastic bowls, plastic covers for plastic bowls, plastic plates, plastic covers for plastic plates, plastic heat-retaining cloches, plastic cutlery, plastic containers for pre-portioning foods, and/or plastic lids for plastic containers for pre-portioning foods.

2. The conveyor warewasher according to claim 1,
wherein an image processing is associated with the camera system, said device being configured to pre-process the at least one image captured by the camera system, to segment the pre-processed image, and to extract features and classify objects contained in the image, wherein the evaluation device is configured in order to evaluate and determine on the basis of the classification performed whether, at the time of the image capture, washware of the washware category “reusable plasticware” was present in the portion of the conveyor apparatus.

3. The conveyor warewasher according to claim 1,
wherein the conveyor warewasher further comprises a control device, which is configured in order to select a predetermined or determinable treatment program automatically for the determined category of washware “reusable plasticware,” according to which program the washware is to be treated in the at least one washing zone and/or in the at least one rinsing zone and/or at least one drying zone, and to set the process parameters associated with the selected treatment program, and/or to set a predetermined or determinable conveyance speed of the conveyor apparatus.

4. The conveyor warewasher according to claim 3,
wherein the control device is configured in order to automatically, upon recognition of the washware category “reusable plasticware,” select a predetermined or determinable value of a volumetric flow of the washing liquid to be sprayed per unit of time in the at least one washing zone and set the volumetric flow of the washing liquid to be sprayed per unit of time to the selected value; and/or
wherein the control device is configured in order to automatically, upon recognition of the washware category “reusable plasticware,” select a predetermined or determinable value of a nozzle pressure with which the washing liquid is sprayed in the at least one washing zone and set the nozzle pressure to the selected value; and/or
wherein the control device is configured in order to automatically, upon recognition of the washware category “reusable plasticware,” select a predetermined or determinable value of a temperature of the washing liquid to be sprayed in the at least one washing zone and set the temperature of the washing liquid sprayed in the at least one washing zone to the selected value; and/or
wherein the control device is configured in order to automatically, upon recognition of the washware category “reusable plasticware,” select a predetermined or determinable value of a volumetric flow of the rinsing liquid to be sprayed per unit of time in the at least one rinsing zone and set the volumetric flow of the rinsing liquid to be sprayed per unit of time to the selected value; and/or
wherein the control device is configured in order to automatically, upon recognition of the washware category “reusable plasticware,” select a predetermined or determinable value of a nozzle pressure with which the rinsing liquid is sprayed in the at least one rinsing zone and set the nozzle pressure to the selected value; and/or
wherein the control device is configured in order to automatically, upon recognition of the washware category “reusable plasticware,” select a predetermined or determinable value of a temperature of the rinsing liquid to be sprayed in the at least one rinsing zone and set the temperature of the rinsing liquid sprayed in the at least one rinsing zone to the selected value; and/or
wherein the control device is configured in order to automatically, upon recognition of the washware category “reusable plasticware,” set a predetermined or determinable value of an amount of rinse aid sprayed per unit of time in the at least one rinsing zone to a selected value; and/or
wherein the control device is configured in order to automatically, upon recognition of the washware category “reusable plasticware,” adjust a predetermined or determinable value of an amount of detergent sprayed per unit of time in the at least one washing zone or in an additional intermediate zone to a selected value; and/or
wherein the control device is configured in order to automatically, upon recognition of the washware category “reusable plasticware,” select a predetermined or determinable value of a volumetric flow/nozzle pressure of drying air to be sprayed per unit of time in the at least one drying zone and set the volumetric flow/nozzle pressure of drying air sprayed per unit of time to the selected value; and/or
wherein the control device is configured in order to automatically, upon recognition of the washware category “reusable plasticware,” switch between different chemical products, between a universal rinsing agent for washware made of porcelain, glass, or metal, and a special rinsing agent for washware made of plastic.

5. The conveyor warewasher according to claim 1,
wherein the conveyor warewasher comprises a control device, which is configured in order to, during a learning or observation phase over at least one observation period or over a plurality of observation periods each relating to a washing shift or a washing day of the conveyor warewasher or a portion thereof, determine a development over time of the loading of the conveyor apparatus with washware of the category “reusable plasticware” to be transported through the treatment zones of the conveyor warewasher, wherein the control device is further configured in order to, based on the determined chronological profile of the loading of the conveyor apparatus with washware of the category “reusable plasticware,” deduce a pattern or a regularity.

6. The conveyor warewasher according to claim 5,
wherein the control device is further configured in order to divide the observation period relating to a washing shift or a washing day of the conveyor warewasher or a portion thereof into a first sub-period and into at least one further second sub-period, wherein, in the first sub-period of the observation period, the determined average loading level of the conveyor apparatus with the washware of the category “reusable plasticware” corresponds to a first relative value or falls within a first relative value range, and wherein, in the at least one second sub-period of the observation period, the determined average loading level of the conveyor apparatus with the washware of the category “reusable plasticware” corresponds to a second relative value or falls within a second relative value range.

7. The conveyor warewasher according to claim 6,
wherein the first relative value of the average loading level of the conveyor apparatus with the washware of the category “reusable plasticware” corresponds to a loading of the conveyor apparatus with this washware category that is larger than the loading of the conveyor apparatus with this washware category relating to the second relative value of the average loading level of the conveyor apparatus with the washware of the category “reusable plasticware”.

8. The conveyor warewasher according to claim 6,
wherein the control device is further configured in order to, after the end of the learning or observation phase, automatically during operation of the conveyor warewasher during a washing shift or during a washing day for the first sub-period, initiate at least one first measure influencing the treatment of the washware of the category “reusable plasticware” in the treatment zones of the conveyor warewasher, and for the at least one second sub-period, to initiate at least one second measure influencing the treatment of the washware of the category “reusable plasticware” in the treatment zones of the conveyor warewasher.

9. The conveyor warewasher according to claim 8,
wherein the measure influencing the treatment of the washware of the category “reusable plasticware” in the treatment zones of the conveyor warewasher is at least one of the measures listed below:
reducing the temperature of the rinsing liquid to be sprayed in the at least one rinsing zone; and/or
reducing the pressure of the rinsing liquid to be sprayed in the at least one rinsing zone; and/or
increasing the amount of rinsing liquid sprayed per unit of time in the at least one rinsing zone; and/or
increasing the temperature of the washing liquid to be sprayed in the at least one washing zone; and/or
reducing the pressure of the washing liquid to be sprayed in the at least one washing zone; and/or
reducing the amount of washing liquid to be sprayed per unit time in the at least one washing zone; and/or
increasing the temperature of the drying air to be sprayed in a drying zone of the conveyor warewasher; and/or
increasing the pressure of the drying air to be sprayed in a drying zone of the conveyor warewasher; and/or
increasing the amount of drying air to be sprayed per unit time in a drying zone of the conveyor warewasher; and/or
increasing the amount of rinse aid to be dosed into the rinsing liquid per unit of time; and/or;
reducing the transport speed of the conveyor apparatus.

10. The conveyor warewasher according to claim 1,
wherein the control device is configured in order to output a notification to the washing personnel associated to the conveyor warewasher and/or to the operator of the conveyor warewasher, when it is determined that a current or—calculated over an predetermined or determinable period of time—average loading level of the conveyor apparatus with washware of the category “reusable plasticware” is above or below a predetermined or determinable loading level of the conveyor apparatus.

11. The conveyor warewasher according to claim 1,
wherein the conveyor warewasher comprises a control device which is configured in order to determine a development over time of the loading of the conveyor apparatus with washware of the category “reusable plasticware” to be transported through the treatment zones of the conveyor warewasher and/or to create statistics about the loading level of the conveyor apparatus with washware of the category “reusable plasticware”.

12. The conveyor warewasher according to claim 11,
wherein the control device is further configured in order to generate a corresponding notification depending on the determined development over time and/or the statistics created, and/or to output it to the operator of the conveyor warewasher, wherein the notification contains a recommendation for optimal operation of the conveyor warewasher with regard to the cleaning efficiency.

13. A method for operating a conveyor warewasher,
wherein the method comprises the following method steps:
during an observation phase over an observation period relating to a washing shift or a washing day of the conveyor warewasher, a development over time of a loading of the conveyor apparatus with washware of the category “reusable plasticware” is determined and, based on the determined development over time, a pattern or regularity is derived; and/or
during an observation phase over an observation period relating to a washing shift or a washing day of the conveyor warewasher, statistics are created regarding the time of the loading level of the conveyor apparatus with washware of the category “reusable plasticware.”

14. The method according to claim 13,
wherein an error or warning message is output, to the washing personnel associated to the conveyor warewasher and/or the operator of the conveyor warewasher when it is determined that the determined and average loading level of the conveyor apparatus with the washware of the category “reusable plasticware” is lower than or greater than a predetermined or determinable loading level.

15. The method according to claim 13,
wherein a corresponding notification is generated and/or output to the operator of the conveyor warewasher depending on the determined development over time and/or the statistics created, wherein the notification contains a recommendation for optimized operation of the conveyor warewasher with regard to the cleaning efficiency.
